(19) United States
(12) Patent Application Publication
(10) Pub. No.: US 2006/0271549 A1
(43) Pub. Date: Nov. 30, 2006

(54) Method and apparatus for central master indexing

(76) Inventors: Geoffrey P. Rayback, Salt Lake City, UT (US); Mark R. Stiegemeier, Park City, UT (US)

Correspondence Address: MOTOROLA, INC., 1303 EAST ALGONQUIN ROAD, IL01/3RD, SCHAUMBURG, IL, 60196, US

(21) Appl. No.: 11/139,055

(22) Filed: May 27, 2005

(51) Int. Cl. G06F 17/30

(52) U.S. Cl. 707/10

(57) ABSTRACT

A method for central master indexing including the steps of creating (202) at least one record for a subject; automatically generating (204) a master record for the subject, the master record comprising a plurality of fields wherein at least a portion of the fields is populated by the most recent data corresponding to that field that is obtained from the at least one record for the subject; and linking (208) each of the records for the subject to the master record.

### FIELD OF THE INVENTION

The present invention relates generally to records management systems and more specifically to a process and architecture for indexing data for efficient retrieval.

### BACKGROUND OF THE INVENTION

In records management systems there exists a need to analyze whether certain records can and should be linked together to facilitate certain processing or actions taken, for instance, relative to data contained in those records. Within the field of law enforcement, for example, an officer at the scene of a current incident such as a burglary may want to further investigate a person who was at the scene of the incident. To further the officer's investigation, information that provides a multi-dimensional view of the person may be needed. Such information may include, for example: whether the person is linked to other incidents (e.g., other prior burglaries or law enforcement related incidents) and in what way; a description or “snapshot” of the person at the time of each incident; and an aggregation of the most recent data about the person at the time of the current incident that the officer is investigating.

There are some known Master Indexing systems that may capture and provide some of the above useful data. However, these systems generally cannot provide the above described multi-dimensional view of data. For example, one system describes a way of taking information from disparate sources and translating the data into objects which the system automatically relates to other objects, for instance relating a person to an incident. In one scenario, an officer may enter data into the system because a warrant is issued for a person. The data is translated into an object and the system automatically attempts to relate the object to other objects in the system. Assuming the system successfully captures all the relationships to the relevant objects, the system may generate a person object related to a warrant object, an arrest object, and a citation object. Thus, the only information we have about the person is encapsulated in this object.

Suppose another officer accesses the data trying to determine if the person described in the object is related to one of his unsolved cases. The officer would typically want to know, for example, what color the person's hair was when he was arrested in a previous incident. However, this type of data is not available in the person object because it is a one-dimensional view of the person. The only data available is the data the officer entered into the warrant. Thus, there is no “snapshot” of the person as he existed at the time of the arrest or any other incident than the one that spawned the record. If the officer needs to know the person's hair color at the point of a specific incident, he will have to find another object that contains that data. This could be difficult if the relationship hierarchy is complex. Even if he succeeds in finding another person object that contains the hair color data he needs, there is no way for him to be sure that he is looking at data about the same person, since it is contained in a different object. For instance, there could be thousands of John Smith objects in the system with no way of distinguishing between the same or different John Smiths.

Thus, there exists a need for a records management system that overcomes the shortcomings of known systems and provides a multi-dimensional view of data, to aid in the analysis of the data.

### BRIEF DESCRIPTION OF THE DRAWINGS

A preferred embodiment of the invention is now described, by way of example only, with reference to the accompanying figures in which:

FIG. 1 illustrates a block diagram of an exemplary records management system suitable for implementing embodiments of the present invention;

FIG. 2 illustrates a flow diagram of a method for central master indexing in accordance with embodiments of the present invention;

FIG. 3 illustrates a list of records in accordance with embodiments of the present invention;

FIG. 4 illustrates a Master Record in accordance with embodiments of the present invention;

FIG. 5 illustrates an involvement record in accordance with embodiments of the present invention;

FIG. 6 illustrates an involvement record in accordance with embodiments of the present invention; and

FIG. 7 illustrates an involvement record in accordance with embodiments of the present invention.

### DETAILED DESCRIPTION OF THE INVENTION

While this invention is susceptible of embodiments in many different forms, there are shown in the figures and will herein be described in detail specific embodiments, with the understanding that the present disclosure is to be considered as an example of the principles of the invention and not intended to limit the invention to the specific embodiments shown and described. Further, the terms and words used herein are not to be considered limiting, but rather merely descriptive. It will also be appreciated that for simplicity and clarity of illustration, common and well-understood elements that are useful or necessary in a commercially feasible embodiment may not be depicted in order to facilitate a less obstructed view of these various embodiments. Also, elements shown in the figures have not necessarily been drawn to scale. For example, the dimensions of some of the elements are exaggerated relative to each other. Further, where considered appropriate, reference numerals have been repeated among the figures to indicate corresponding elements.

Generally speaking, pursuant to the various embodiments, the present invention provides a method and architecture for tracking a relationship between multiple instances of data that relate to the same real-world entity (e.g., a person, property, group or organization, place or location, object, etc.). As a result, a user may obtain a multi-dimensional view of those multiple instances of data to enhance analysis of the data. Those skilled in the art will realize that the above recognized advantages and other advantages described herein are merely exemplary and are not meant to be a complete rendering of all of the advantages of the various embodiments of the present invention.

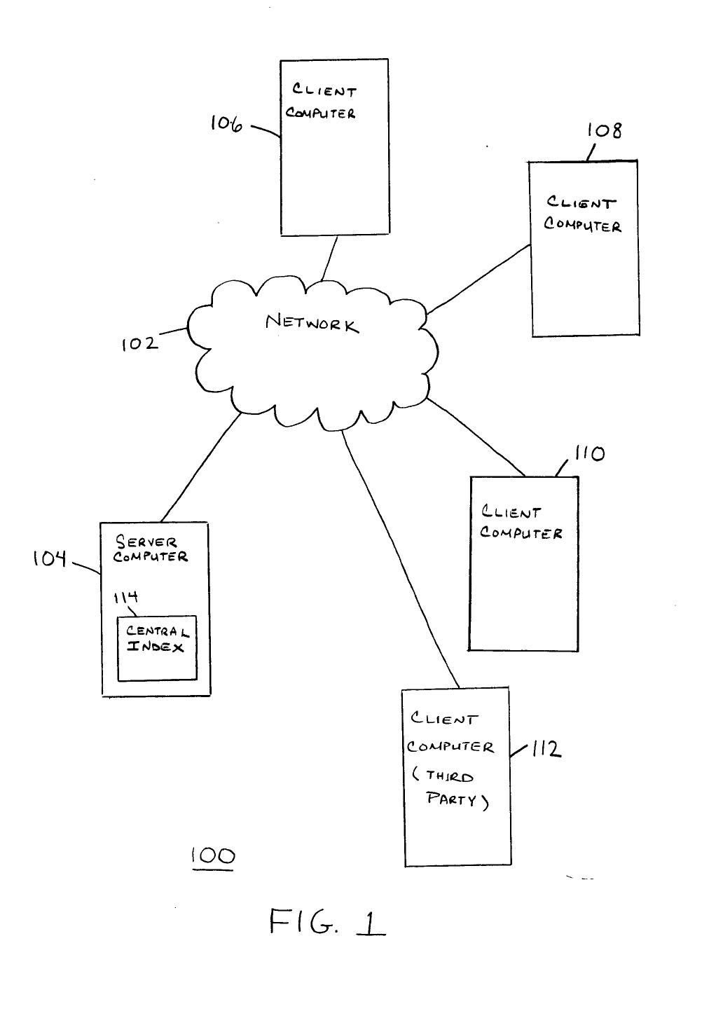

Referring now to the drawings, and in particular FIG. 1, a block diagram of an exemplary records management system suitable for implementing embodiments of the present invention is shown and indicated generally at 100. Those skilled in the art, however, will recognize and appreciate that the specifics of this illustrative example are not specifics of the invention itself and that the teachings set forth herein are applicable in a variety of alternative settings. For example, since the teachings described do not depend on the particular system architecture use, they can be applied to any type of system architecture used although a client/server model is shown in this embodiment. As such, other alternative implementations of using different types of system architectures are contemplated and are within the scope of the various teachings described. Moreover, in the following illustrations, embodiments of the present invention make specific mention of its use in the context of law enforcement. However, those skilled in the art will readily realize that the principles of the present invention described herein are not limited to such an implementation, but that these principles may be applied in other contexts such as in records management for health care, social services, and the like without loss of generality.

System 100 comprises a network 102, which is the medium used to provide communications links between various devices and computers connected together within system 100. Network 102 may include permanent connections, such as wire or fiber optic cables, or temporary connections made through telephone connections or wireless connections, although the particular embodiment of the present invention illustrated herein may include wire and/or wireless connections for transmitting data to and from, for instance, patrol vehicles and crime scenes. Moreover, network 102 may represent the Internet or one or more other types of networks such as, for instance, an intranet, a Local Area Network (LAN), a Wide Area Network (WAN), etc.

System 100 further comprises a server computer 104, client computers 106, 108, 110, 112 coupled to server computer 104 via network 102 and a central index module 114 typically coupled to and/or executed on the server computer 104 and operative in accordance with embodiments of the present invention. Server computer 104 typically includes suitable hardware (e.g., a processor, memory, etc.) as is well known in the art and software (e.g., implemented in the languages C++ and Visual Basic) for implementing embodiments of the present invention. Client computers 106, 108, 110, 112 also typically include suitable hardware (e.g. a processor, memory, transceiver, etc.) as is well known in the art and software (e.g., implemented in the languages C++ and Visual Basic) for implementing embodiments of the present invention. Client computers may be, for example, personal computers, personal digital assistants (PDAs), network computers, etc. Moreover, the client computers may comprise one or more computers associated with a given user group (e.g., client computers 106, 108, 110) and one or more computers not so associated (e.g., a third party computer 112). In one embodiment, server 104 may provide data, such as boot files, operating system images, and applications to client computers 106, 108, 110, 112, and the client computers may be clients to server 104. Central index module 114 may, for example, be implemented using suitable hardware and software such as a data storage device, one or more processes executed on server 104 and one or more processes executed on client computers 106, 108, 110, 112. System 100 may further comprise additional servers, clients, central index modules, and other devices not shown.

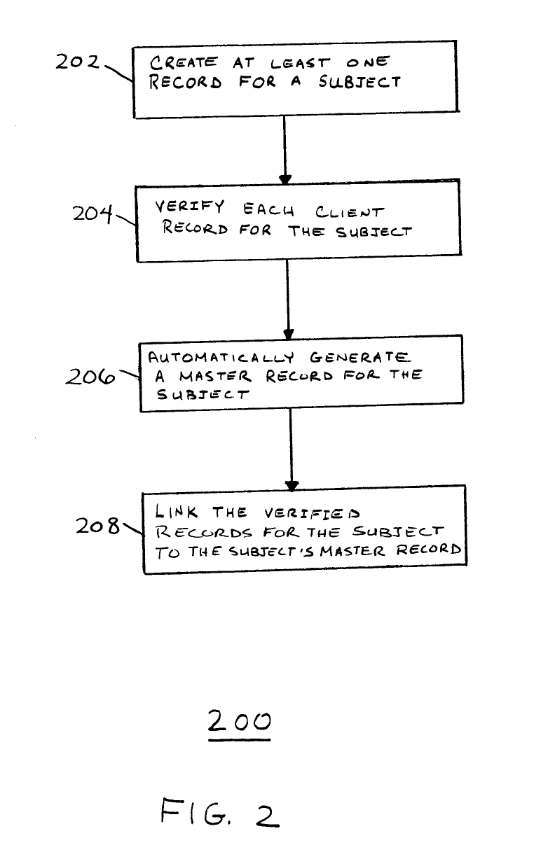

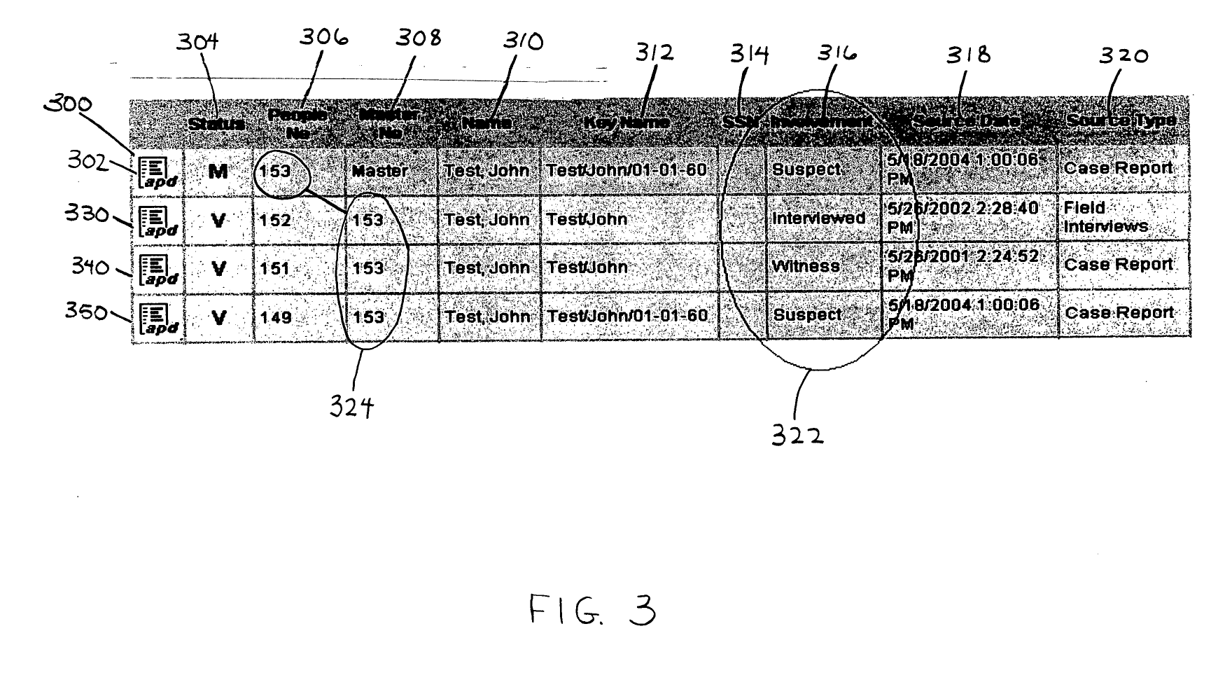

Turning now to FIG. 2, a flow diagram of a method for central master indexing in accordance with embodiments of the present invention is shown and generally indicated at 200. In general, method 200 includes: creating at least one record for a subject at step 202; automatically generating a master record for the subject at step 206; and linking each of the records for the subject to the master record at step 208. In various embodiments, method 200 may further include verifying each record for the subject at step 204 and linking only those verified records to the master record at step 208. A detailed implementation of method 200 will be further explained by reference to FIGS. 3 through 7.

In order to show a practical example of these various teachings, a particular implementation is described in a law enforcement context with the subject being a person. However it should be readily appreciated by one skilled in the art that the principles of the invention are not limited to this implementation or context. Embodiments of the present invention may be, for example, implemented in health care, and social services contexts. Moreover, the subject is not limited to a person but may be a property such as a vehicle or firearm, an organization, gang or other group, a location or place such as an address or an intersection, any other type of object, etc.

Returning now to the detailed description of FIG. 2, at step 202, in one embodiment, one or more records for a subject may be created in the server 104 and stored in a database at the central index module 114. Each record is typically a “snapshot” or an instance relating to the subject, and gives details or data corresponding to the subject at that instance. Data for populating a record may be obtained, for example, from a client computer that may be one of a plurality that share a LAN (e.g., 106, 108, 110) or from a third party client computer (e.g., 112). The data may be entered by a user into the client computer using a suitable user interface or otherwise input into the client computer using other means such as by scanning a document into the computer using a scanning device operatively coupled to system 100 or transmitting data into the computer from a peripheral device such as a digital camera.

Once the data is captured in the client computer, it may be processed by suitable software in the client computer into a common format for use by the server computer 104. In one embodiment, the client computer formats the data into an Extensible Markup Language (XML) document and sends it to the server computer 104. By the client formatting the data into a common and standard format like XML, embodiments of the present invention may be implemented wherein records can be created regardless of where the data comes to the server from and regardless of how the data is stored at the client end, and data can be more easily shared across organizations. Once at the server, the data for a given instance is used to automatically generate a corresponding record (e.g., an instance record), typically having a plurality of fields into which the data is formatted, and the record may be stored in a database of the central index module for searching and for indexing in accordance with embodiments of the present invention.

Upon creating the record it may be verified, for example manually by a user at the client end, before linking the record to a master record. In one embodiment, a group of users (such as users from a law enforcement agency) may have responsibilities that include verifying for each record that the record corresponds to a given subject. For instance, where the subject is a person the record may be verified to the person based on one or more parameters such as the person's social security number, birth date, driver's license number, etc. Upon verifying a client record (if the verification step 204 is performed), a master record for the subject may be generated.

Generating a master record may comprise automatically creating a master record for the subject if none already exists in the database of the central index module. The master record comprises a plurality of fields, wherein at least a portion of those fields correspond to fields in each record that may be linked to the master record and ideally at least comprises all of the fields represented in each record that may be linked to the master record. In one embodiment, the fields in the master record are predetermined and are common to the fields in each of the records linked to it. In another embodiment, the fields in the master record may be determined based on the fields in the one or more records assigned to the master record.

The master record is essentially an aggregate of the most recent data from each record linked to it, wherein at least a portion of the fields in the master record are populated by the most recent data corresponding to that field that is obtained from a record that is linked to the master record. A record corresponding to the subject (e.g., a verified record) may be linked to the master record for the subject, for example, using a pointer from the record to the master record that may be generated at the server 104, thus serving to associate a master record for a subject with all of the instance records for the subject. The master record and pointers to the master record may, thus, serve as a unique identifier for a subject regardless of the source or number of instance records that correspond to this same subject and that are linked to the master record.

Where a master record already exists for a subject, any additional records created for the subject (e.g., and verified) may be linked to the already existing master record. Moreover, the master record may be automatically updated based upon data contained in the newly linked instance record that was more recent than the data the master record currently had so that it contains that most recent known data about the subject. Updating may include populating a field that had not yet been populated. In one embodiment, a user at the client end may at a client computer, for instance, assign a verified record to a given master record so that a link from that record to the master record may be generated.

Once created and stored, the instance records and the corresponding master records may be searched and viewed by a client computer, for example, having suitable software and/or user interface. In one embodiment, components executed on a client computer for viewing the stored data may be implemented using HyperText Markup Language (HTML) and an Active Server Page (ASP).

A better understanding of the principles of the present invention may be had by describing a practical illustration of the implementation of these principles. This practical illustration will be described by reference to FIGS. 3 through 7, wherein the context is law enforcement, the subject is a person, and the instance records (referred to in this illustration as involvement records) correspond to the person's involvement in a given incident (e.g., of crime). As stated above, this illustration is not meant to limit the invention but to assist in a better understanding of the principles of the invention.

In this illustration, an officer is investigating a suspected arson. A nightclub burned down, and he suspects that the fire was caused intentionally. He interviewed several witnesses at the scene. One of the witnesses was named John Test. The investigator performs, using a client computer, a search of the records in the database of the central index module 114 for people named John, and finds several records. The search may be for instance performed based on master record association. FIG. 3 is an exemplary screen shot displayed on the investigator's client computer and comprising a list of four records (300, 330, 340, 350) returned as a result of the investigator's search. Each record in the list has associated with it a corresponding icon 302 that the investigator may use to view a screenshot of the details of the record. Each record also has associated with it a plurality of fields in the screen shoot. In this illustration, those fields include status (304), people number (306), master number (308), name (310), key name (312), social security number (SSN) (314) involvement (316), source date (318) and source type (320). The screen shot may contain other fields corresponding to the records without departing from the scope of the teachings of the present invention.

Using Mr. Test's driver's license information taken during the interview, the officer is able to determine that the John Test he interviewed matches a John Test already in the system, and that John Test has been involved in three previous incidents as identified in oval 322, and each time an involvement record (e.g., 330, 340, 350) stored a “snapshot” of John Test at the time of the incident. The involvement records for John Test are further linked to a master record 300 (as identified by an oval 324) that is identified by a master record number 153. In this way, the officer may identify and confirm which records (300, 330, 340, 350) are related to John Test. And where there are involvement records related to more than one person having the name John Test, the officer can be assured that the verified involvement records relating to a John Test that are not linked to master record 153 do not correspond to his witness.

The data about Mr. Test was likely verified (for example by a separate division within the law enforcement agency employing the officer) to make sure that it was accurate based on the protocols of the agency. Once each new record was verified, the verifying officer determined that the same John Test already existed in the system, so the new record was associated to the existing Master Record for John Test. The Master Record then updated itself with any information contained in the new involvement record that was more recent than the data it currently had, so that it contained that most recent known data about John Test.

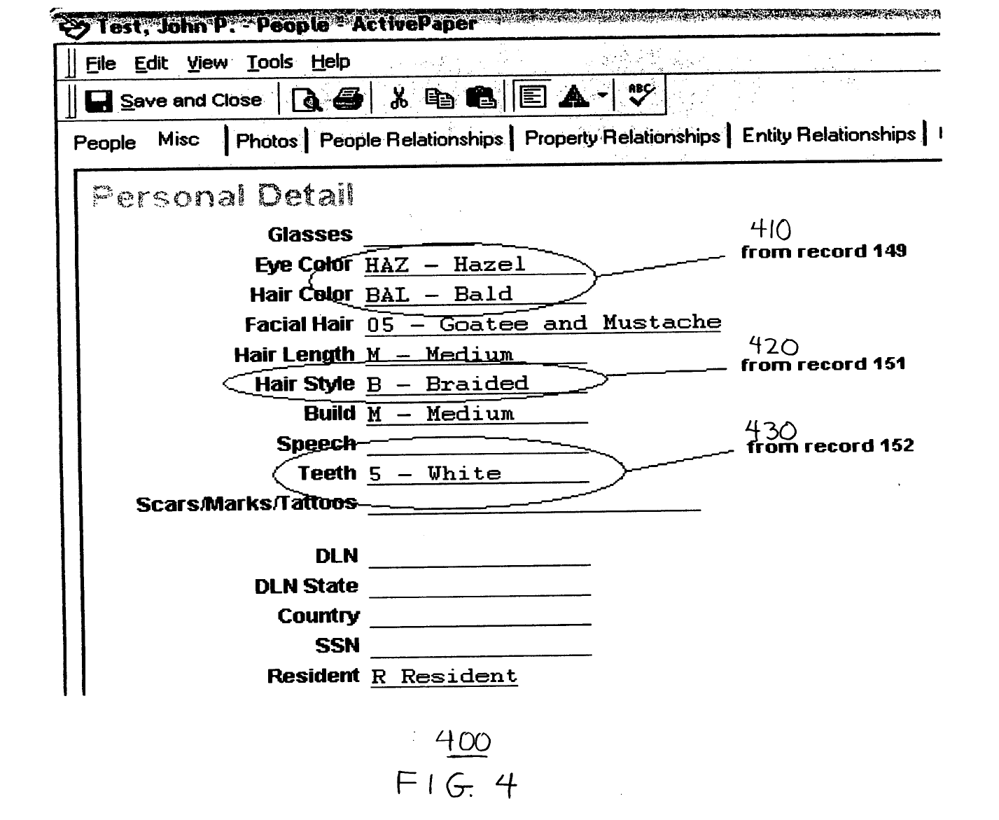

The Officer may desire to open the Master Record 300 for John Test to see the most recent data corresponding to John Test. FIG. 4 illustrates an exemplary screen shot of Master Record 300 on the officer's client computer that is displayed by the officer clicking the corresponding icon 302. As can be seen, the Master Record comprises a plurality of fields, some of which are not populated. However, those fields that are populated obtain data from one or more of the corresponding involvement records (e.g., 330, 340, 350). Since the Master Record is an aggregate of the most recent data about this individual, it may list his most recent involvement in an incident (not shown). For example, the investigating officer may notice that John Test was most recently a suspect in a Case Report that also involved the arson of a nightclub, which may cause the officer to suspect that Mr. Test may be involved in starting the fire at this current incident. However, the officer may need more information than he can get from the Master Record before arresting Mr. Test in connection with the current incident.

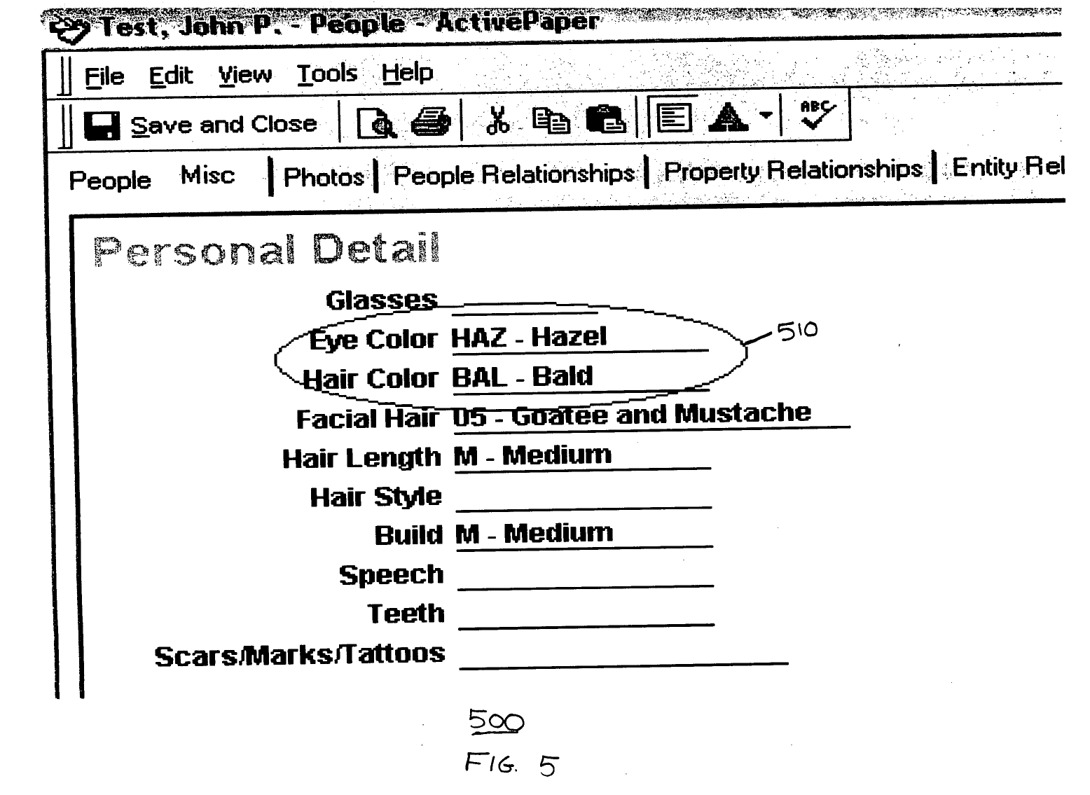

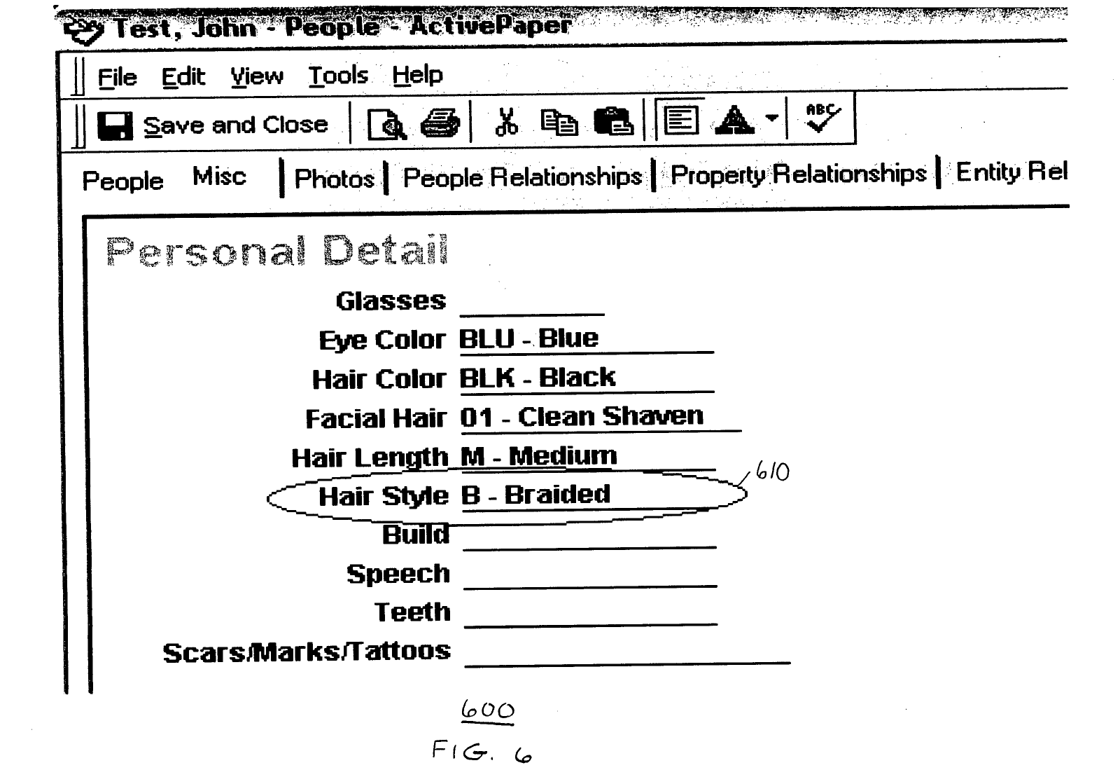

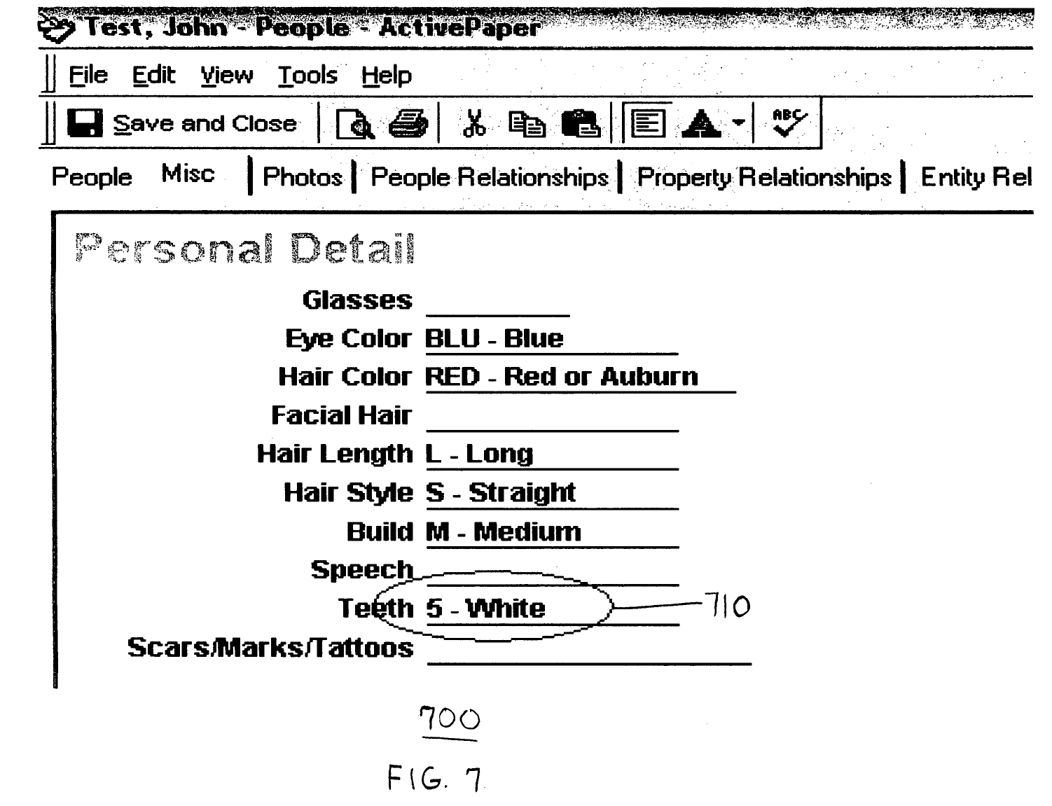

The officer may then proceed to click on the corresponding icons 302 for each involvement record (330, 340, 350) for John Test to open each individual involvement record. FIG. 5 illustrates an exemplary screen shot for the involvement record 350 for a Case Report. FIG. 6 illustrates an exemplary screen shot for the involvement record 340 for a Case Report. FIG. 7 illustrates an exemplary screen shot for the involvement record 330 for field interviews. Each involvement record comprises a plurality of fields. It should be noted that in this illustration Master Record 300 comprises most recent data from each of the involvement records 330, 340, 350. For example, the most recent data regarding Mr. Test's eye color and hair color was obtained from involvement record 350 (as identified by ovals 410 in FIGS. 4 and 510 in FIG. 5). The most recent data regarding Mr. Test's facial hair style was obtained from involvement record 340 (as identified by ovals 420 in FIGS. 4 and 610 in FIG. 6). The most recent data regarding Mr. Test's teeth was obtained from involvement record 330 (as identified by ovals 430 in FIGS. 4 and 710 in FIG. 7).

The officer notes that all three of the involvement records involved a fire. Even though John Test was only a suspect in one of the incidents, he was physically present for all three. He also notices that John Test attempted to change his appearance after each event. He changed his hair color and length and changed his facial hair. Based on this new information, the officer decides he has enough to arrest John Test, so he checks the Master Record again to find John Test's last known address and phone number (not shown) in case they are different from what is listed on his driver's license, which they are. He dispatches officers to wait for Mr. Test at his last known address.

This practical illustration further serves to highlight some of the advantages of the present invention. For example, the officer was able to quickly and easily find all the information he needed about John Test. Using three dimensions of the data he was able to see a larger view of the individual than he would have been able to with only one or two dimensions. From the pointers that point to the Master Record he was able to determine that the John Test he interviewed already existed in the agency's database and that he was the same John Test that had been involved in three previous incidents. From the Master Record, he noticed that John Test had been a suspect in an arson. In addition, he was able to find Mr. Test's last known address and phone number, which turned out to be more recent than the out of date driver's license information he had taken down in his interview. From the involvement records he was able to determine that John Test had been involved in several other incidents involving a fire and that he had drastically changed his appearance after each one, implicating him as a suspect. Without the multi-dimensional approach to storing and retrieving data provided by embodiments of the present invention, the officer would likely have had a difficult time assembling all the relevant information about John Test, and very probably would not have thought to make the connections that were obvious to him in viewing Mr. Test's Master Record and various individual involvement records that were linked to that Master Record.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

What is claimed is:

1. A method for central master indexing comprising the steps of:
creating at least one record for a subject;
automatically generating a master record for the subject, the master record comprising a plurality of fields wherein at least a portion of the fields is populated by the most recent data corresponding to that field that is obtained from the at least one record for the subject; and
linking each of the records for the subject to the master record.

2. The method of claim 1, wherein the subject is one of a person, a group, a place, a property, and an object.

3. The method of claim 1, further comprising verifying that a record corresponds to the subject before linking the record to the master record and including data from the record in the master record.

4. The method of claim 3, wherein the record is manually verified.

5. The method of claim 1, wherein linking each of the records for the subject to the master record comprises generating a corresponding pointer from each of the records for the subject to the master record.

6. The method of claim 1, wherein the master record and each of the records for the subject are law enforcement records and the incident is a law enforcement related incident.

7. The method of claim 1, wherein creating at least one record for the subject comprises:
receiving data corresponding to the subject and an incident; and
automatically generating the at least one record for the subject based on the received data.

8. The method of claim 7, wherein the incident is a crime incident.

9. The method of claim 1 further comprising:
creating a new record for the subject;
linking the record to the subject; and
automatically updating the master record based on the most recent data obtained from the new record.

10. The method of claim 9, wherein a user assigns the new record to the master record using a client computer and the record is linked to the master record based on that assignment.

11. The method of claim 1, wherein each record for the subject is based upon data entered into a client computer by a user and received at server.

12. The method of claim 11, wherein the data is received at the server in an Extensible Markup Language (XML) format.

13. The method of claim 1, wherein the at least one record for the subject and the master record are displayed on a client computer using at least one of a HyperText Markup Language (HTML) and an Active Server Page (ASP).

14. A method for central master indexing in a records management system for law enforcement, the method comprising the steps of:
creating at least one law enforcement record for a subject;
verifying each of the law enforcement records for the subject;
automatically generating a master law enforcement record for the subject, the master record comprising a plurality of fields wherein at least a portion of the fields is populated by the most recent data corresponding to that field that is obtained from the at least one verified law enforcement record for the subject; and
linking each of the verified law enforcement records for the subject to the master law enforcement record.

15. Apparatus for central master indexing comprising:
a processor;
a memory; and
a storage device, each operatively coupled together and at least one of the processor, memory and storage device being configured for:
creating at least one record for a subject;
automatically generating a master record for the subject, the master record comprising a plurality of fields wherein at least a portion of the fields is populated by the most recent data corresponding to that field that is obtained from the at least one record for the subject; and
linking each of the records for the subject to the master record.

16. The apparatus of claim 15 comprising a server computer and a central index module.
